(19) United States
(12) Patent Application Publication
(10) Pub. No.: US 2026/0120708 A1
(43) Pub. Date: Apr. 30, 2026

(54) SYSTEMS AND METHODS FOR MANAGING CASCADING MODELS

(71) Applicant: Comcast Cable Communications, LLC, Philadelphia, PA (US)

(72) Inventors: Raphael Tang, Washington, DC (US); Yajie Mao, Philadelphia, PA (US); Karun Kumar, Philadelphia, PA (US); Ferhan Ture, Philadelphia, PA (US)

(21) Appl. No.: 18/927,993

(22) Filed: Oct. 26, 2024

(51) Int. Cl. G10L 25/30; G10L 15/22

(52) U.S. Cl. CPC G10L 25/30; G10L 15/22

(57) ABSTRACT

Methods may include receiving, via a computing device, a query. Methods may include causing, based on the query, input of a first prompt to a first model. Methods may furthermore include receiving, via the first model, a first output. Methods may include determining, based on the first output, a confidence score. Methods may include determining, based on a comparison of a first performance of the first model and a second performance of a second model, a threshold. Methods may include causing, based on the confidence score not satisfying the threshold, input of a second prompt to the second model. The second prompt may be based at least on the query. Methods may include receiving, via the second model, a second output. Methods may include causing, based on the query, the second output to be output via the computing device.

### BACKGROUND

Machine learning models may be used in a number of operations. Selection of particular models for a given application attempts to balance the cost of the model (e.g., power consumption and processing time) with the confidence of the output.

Improvements are needed.

### SUMMARY

It is to be understood that both the following general description and the following detailed description are exemplary and explanatory only and are not restrictive. Methods and systems for managing cascading models are described.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Methods may include receiving, via a computing device, a query. Methods may include causing, based on the query, input of a first prompt to a first model. The first model may include a first large language model (LLM). Methods may include receiving, via the first model, a first output. Methods may include determining, based on the first output, a confidence score. The confidence score may be based, at least in part, on a number of times a previous query has been the same as the query. The confidence score may be based, at least in part, on feedback received the number of times the previous query has been the same as the query. Methods may include determining, based on a comparison of a first performance of the first model and a second performance of a second model, a threshold. The second model may include a second LLM. The comparison of the first performance and the second performance may include a comparison of at least one of accuracy, negative log-likelihood, or perplexity. Methods may include causing, based on the confidence score not satisfying the threshold, input of a second prompt to the second model. The second prompt may be based at least on the query. Methods may include receiving, via the second model, a second output. Methods may include causing, based on the query, the second output to be output via the computing device. Other embodiments of this aspect include corresponding computer systems, apparatus, and computer programs recorded on one or more computer storage devices, each configured to perform the actions of the methods.

Methods may include receiving, via a computing device, a query. Methods may include causing, based on the query, input of a first prompt to a first model. Methods may furthermore include receiving, via the first model, a first output. Methods may include determining, based on the first output, a confidence score. Methods may include determining, based on a comparison of a first performance of the first model and a second performance of a second model, a threshold. Methods may include causing, based on the confidence score not satisfying the threshold, input of a second prompt to the second model. The second prompt may be based at least on the query. Methods may include receiving, via the second model, a second output. Methods may include causing, based on the query, the second output to be output via the computing device. Other embodiments of this aspect include corresponding computer systems, apparatus, and computer programs recorded on one or more computer storage devices, each configured to perform the actions of the methods.

Methods may include receiving, via a computing device, a query. Methods may include causing, based on the query, input of a first prompt to a first model. Methods may include receiving, via the first model, a first output. Methods may include determining, based on the first output, a confidence score. Methods may include determining, based on a comparison of a first performance of the first model and a second performance of a second model, a threshold. Methods may include causing, based on the confidence score satisfying the threshold, the first output to be output via the computing device. Other embodiments of this aspect include corresponding computer systems, apparatus, and computer programs recorded on one or more computer storage devices, each configured to perform the actions of the methods.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example environment for managing cascading models.

FIG. 2 shows an example process for managing cascading models.

FIG. 3 shows example graphs comparing performance of conventional systems to the systems and methods described herein.

FIG. 4 shows an example graph comparing average loss of various methods, including the systems and methods described herein.

FIG. 5 shows an example method in accordance with the present disclosure.

FIG. 6 shows an example method in accordance with the present disclosure.

FIG. 7 shows an example method in accordance with the present disclosure.

The accompanying drawings show examples of the disclosure. It is to be understood that the examples shown in the drawings and/or discussed herein are non-exclusive and that there are other examples of how the disclosure may be practiced.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

The present disclosure relates to systems and methods for managing cascading models. Disclosed herein are systems and methods related to risk control for cascading models (e.g., machine learning (ML) models, large language models (LLMs), etc.). The systems and methods described herein may determine which of two (or more) available models to use to perform a function or respond to a query. A first model may comprise a relatively small model. The first model may return output relatively quickly. A second model may comprise a relatively large model (e.g., compared to the first model). The second model may return output relatively slowly (e.g., compared to the first model). The first model may use less computing power than the second model. The first model may reside on a computing device local to a premises. The second model may reside on a computing device remote from the premises. Other configurations and model locations may be used.

The systems and methods described herein may determine a threshold that will be used to determine which of the two (or more) models to use. The threshold may be determined based on a comparison of performance of two or more models. As an example, the threshold is determined based on a probability distribution of performance of one or more of the models. When a model produces a result, the model may also return a confidence score related to a presumed correctness of the result. The confidence score may be compared to the determined threshold, and a decision may be made about which model to use. For example, the first model may be a default for use. The first model may receive a query and return an output and a confidence score. The confidence score may be compared to the threshold. If the confidence score is above the threshold, then the output from the first model may be used. If the confidence score is below the threshold, then the query may be provided to the second model, wherein output from the second model may be used.

The systems and methods disclosed herein may be applicable to how user queries are handled by customer interfaces and user interfaces (UIs). Various end-use applications may benefit from the systems and methods disclosed herein.

As an illustrative example, a small but specific keyword spotting system may be running on a smart device (e.g., first model), which falls back to a large-scale speech recognition system running in the cloud (e.g., second model). The first model outperforms the second on a specific set of keywords when the produced confidence score is high.

As another illustrative example, a precise but low-coverage first-stage rule-based natural language processing (NLP) system may be configured for recognizing TV queries, which falls back to a second-stage deep NLP system if the confidence score is below a threshold. Other applications and systems may be used.

The systems and methods disclosed herein may comprise marginal risk control for opposing cascading models. Disclosed herein are two-stage cascading machine learning systems comprising at least two sequential models, a first model deferring to a second model if a confidence score corresponding to output of the first model does not satisfy a threshold (threshold value, etc.). The second model may produce second output and a second confidence score corresponding to the second output. The second model may defer to a third model if the second confidence score does not satisfy a second threshold value, and so on. The second threshold may comprise the threshold.

Conventional practice dictates choosing the threshold using a receiver operating characteristic (ROC) curve at some desired risk--recall trade-off. However, this approach fails to properly control the risk in the opposing setting where the first model outperforms the second model (or an earlier model outperforms a later model) on a subset of high-confidence queries.

The systems and method described herein comprise selecting threshold comprising concentration bounds on an empirical risk of opposing cascading systems. As an example, the marginal risk RM of the cascading system (h1, s1, h2, τ) is

$$R M ( τ ) := sup \{ P ( ℓ ( h 1 ( X ) ) > ℓ ( h 2 ( X ) ) ) : s 1 ( X ) ∈ T , T ⊆ [ τ , ∞ ) \} \qquad ( 3 )$$

More generally, marginal risk reflects the maximum conditional probability that the first model/system underperforms the second model/system, given that the confidence score is in some subset lower-bounded by τ. Using a finite sample, a threshold may be selected that upper bounds the marginal risk of the system to α with probability 1−δ. As a further example, the threshold may be selected based on a probability distribution of performance of one or more of the models.

As a further example, a threshold t′ may be determined from empirical data such that

$$P ( R M ( {τ}^{′} ) \leq α ) \geq 1 - δ \qquad ( 4 )$$

for some provided 0≤δ≤1 and 0≤α≤1. Given a sample X1, . . . , Xn and assume nothing about P(X), only that h1 and h2 are opposing, one may partition X1, . . . , Xn uniformly by confidence score, bound the expected loss difference of each partition, then pick the τ′ that satisfies Eqn. (4) for each partition above τ′. Other processes may be used to select the threshold. Thresholds may be based on a comparison of performance of one or more models. Thresholds may be based on a probability distribution that a model may perform at a certain level (e.g., above or below the threshold based on the probability distribution).

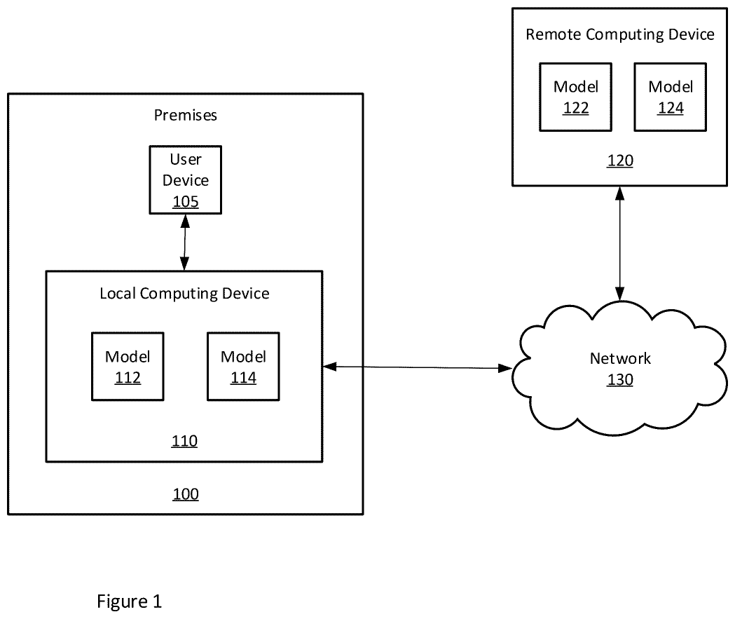

FIG. 1 shows an example environment for managing cascading models. The environment may comprise a premises 100, a user device 105 on the premises, a local computing device 110 on the premises, a remote computing device 120 remote from the premises 100, and a network 130 connecting the local computing device 110 and the remote computing device 120. The local computing device 110 may comprise one or more models, such as a first local model 112 and a second local model 114. The remote computing device 120 may comprise a first remote model 122 and a second remote model 124.

The premises 100 may comprise a residential premises. The premises 100 may comprise a commercial premises. The premises 100 may comprise an industrial premises. The premises 100 may be associated with a subscriber of a service provider. The service provider may provide access to the network 130. The service provider may provide access to the remote computing device 120.

The user device 105 may be associated with the service provider. The user device 105 may be associated with the subscriber. The local computing device 110 may comprise one or more of a smartphone, tablet, remote control, laptop, desktop computer, wearable computing device, Internet of Things (IoT) device, set-top box, modem, gateway, router, etc.

The local computing device 110 may be associated with the service provider. The local computing device 110 may be associated with the subscriber. The local computing device 110 may comprise one or more of a smartphone, tablet, laptop, desktop computer, wearable computing device, Internet of Things (IoT) device, set-top box, modem, gateway, router, etc.

The first local model 112 may comprise a first large language model (LLM). The first local model 112 may be configured to produce output relatively quickly. The first local model 112 may be trained with a relatively small corpus. The first local model 112 may be trained with a relatively specialized corpus. The first local model 112 may use relatively low computing power. The first local model 112 may use relatively few tokens. The first local model 112 may be a default model. The first local model 112 may produce a confidence score along with output. If the confidence score does not satisfy a threshold, then another model, such as the second local model 114 or the second remote model 124, may be queried.

The second local model 114 may comprise a second large language model (LLM). The second local model 114 may be configured to produce output relatively slowly. The second local model 114 may be trained with a relatively large corpus. The second local model 114 may be trained with a relatively generalized corpus. The second local model 114 may use relatively high computing power. The second local model 114 may use relatively many tokens. The second local model 114 may be a backup model. The second local model 114 may produce a confidence score along with output. If the confidence score does not satisfy a threshold, then another model, such as a third local model or the second remote model 124, may be queried. Although both are shown as residing in the local computing device 110, the first local model 112 may reside in a first local computing device and the second local model 114 may reside in a second local computing device. Other configurations may be used.

The remote computing device 120 may comprise one or more servers. The remote computing device 120 may reside in a cloud computing environment. The remote computing device 120 may be associated with the service provider.

The first remote model 122 may comprise a first large language model (LLM). The first remote model 122 may be configured to produce output relatively quickly. The first remote model 122 may be trained with a relatively small corpus. The first remote model 122 may be trained with a relatively specialized corpus. The first remote model 122 may use relatively low computing power. The first remote model 122 may use relatively few tokens. The first remote model 122 may be a default model. The first remote model 122 may produce a confidence score along with output. If the confidence score does not satisfy a threshold, then another model, such as the second remote model 124 or the second local model 114, may be queried.

The second remote model 124 may comprise a second large language model (LLM). The second remote model 124 may be configured to produce output relatively slowly. The second remote model 124 may be trained with a relatively large corpus. The second remote model 124 may be trained with a relatively generalized corpus. The second remote model 124 may use relatively high computing power. The second remote model 124 may use relatively many tokens. The second remote model 124 may be a backup model. The second remote model 124 may produce a confidence score along with output. If the confidence score does not satisfy a threshold, then another model, such as a third remote model or the second local model 124, may be queried. Although both are shown as residing in the remote computing device 120, the first remote model 122 may reside in a first remote computing device and the second remote model 124 may reside in a second remote computing device.

When multiple models are combined in a cascading system, a threshold may be determined by measuring a performance of the multiple models. For example, the first local model 112 and the second local model 114 may be combined into a cascading system. As another example, the first remote model 122 and the second remote model 124 may be combined into a cascading system. As another example, the first local model 112 and the second remote model 124 may be combined into a cascading system. As another example, the first remote model 122 and the second local model 114 may be combined into a cascading system. As another example, the first local model 112, the second local model 114, and the second remote model 124 may be combined into a cascading system. As another example, the first local model 112, the first remote model 122, the second local model 114, and the second remote model 124 may be combined into a cascading system. Measuring the performance may comprise using one or more loss functions to measure one or more of accuracy, negative log-likelihood, or perplexity.

The network 130 may comprise a public network, such as the Internet. The network 130 may comprise a private network. The network 130 may comprise a blockchain network. The network 130 may be associated with the service provider.

A user at the premises 100 may cause a query to be received at the local computing device 110 from the user device 105. The local computing device 110 may use the query to create a first prompt. The local computing device 110 may cause the first prompt to be input to the first local model 112. The local computing device 110 may receive a first output from the first local model 112. The local computing device 110 may use the first output to determine a confidence score. The local computing device 110 may determine a threshold based on a comparison of a first performance of the first local model 112 and a second performance of the second remote model 124. The local computing device 110 may compare the confidence score to the threshold. The local computing device 110 may determine that the confidence score does not satisfy the threshold. The local computing device 110 may use the query to create a second prompt. The local computing device 110 may cause the second prompt to be input to the second remote model 124 via the network 130. The local computing device 110 may receive second output from the second remote model 124. The local computing device 110 may cause the second output to be output. For example, the local computing device 110 may cause the second output to be displayed on a screen and/or verbalized through one or more speakers.

A user at the premises 100 may cause a voice command to be received at a set-top box, using a remote control. The set-top box may transmit the query to a modem. The modem may use the query to create a first prompt. The modem may cause the first prompt to be input to a model local to the modem. The modem may receive a first output from the model local to the modem. The modem may use the first output to determine a confidence score. The modem may determine a threshold based on a comparison of a first performance of the model local to the modem and a second performance of a model located at a server in a content distribution network. The modem may compare the confidence score to the threshold. The modem may determine that the confidence score does not satisfy the threshold. The modem may use the query to create a second prompt. The modem may cause the second prompt to be input to the model located at the server in the content distribution network via the content distribution network. The modem may receive second output from the model located at the server in the content distribution network. The modem may cause the second output to be output. For example, the modem may cause the second output to be displayed on a screen and/or verbalized through one or more speakers.

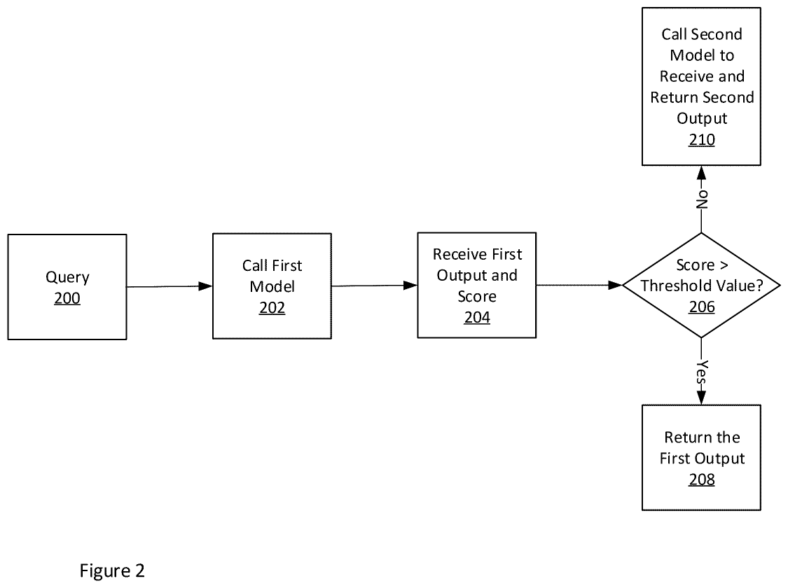

FIG. 2 shows an example process for managing cascading models. At step 200, the process may begin with a query. The query may involve any query that may use a cascading model system. The query may involve interpretation of the query. For example, the query may involve a voice command. The query may be used to create a first prompt.

At step 202, a first model may be called. The first model may be called using the first prompt. The first model may comprise a first large language model (LLM). The first model may be configured to produce output relatively quickly. The first model may be trained with a relatively small corpus. The first model may be trained with a relatively specialized corpus. The first model may use relatively low computing power. The first model may use relatively few tokens. The first model may be a default model. The first model may produce a confidence score along with output.

At step 204, first output and an associated confidence score may be received from the first model in response to the first prompt. The confidence score may indicate a confidence in the first output in responding to the first prompt. The confidence score may be based on a history. For example, the more recent and/or more frequently the first prompt has been input into the first model in the past, the higher the confidence score may be.

At step 206, the confidence score may be compared to a threshold (threshold value, etc.). The threshold may be determined by measuring a performance of the first model and measuring a performance of a second model. Measuring the performance may comprise using one or more loss functions to measure one or more of accuracy, negative log-likelihood, or perplexity. If the confidence score satisfies the threshold, then the process may move to step 208, where the first output is returned.

If the confidence score does not satisfy the threshold, then the process may move to step 210. At step 210, the query may be used to make a second prompt. The second prompt and the first prompt may be the same. The first prompt and/or the second prompt may comprise the query. The second model may be called. The second model may be called using the second prompt. The second model may comprise a second large language model (LLM). The second model may be configured to produce output relatively slowly. The second model may be trained with a relatively large corpus. The second model may be trained with a relatively generalized corpus. The second model may use relatively high computing power. The second model may use relatively many tokens. The second model may be a backup model.

At step 200, a voice command may be received. The voice command may comprise a voice command may comprise instructions to tune a set-top box to a first channel. The voice command may be received at a first time. Voice commands with similar instructions may be received at similar times in earlier days. At step 202, the voice command may be given to a first model. The first model may be local to a premises. The first model may be reinforced through use with voices of users at the premises. The first model may be reinforced through use with phrases used by the users at the premises. At step 204, first output and a confidence score may be received. The first output may comprise confirmation of instructions to tune to the first channel. The first output may comprise a signal to cause the set-top box to tune to the first channel. The confidence score may be based on a history of prior voice commands.

At step 206, the confidence score may be compared with a threshold value. If the confidence score satisfies the threshold, then the first output may be returned (e.g., the confirmation may be displayed, the channel may be tuned, etc.) at step 208. If the confidence score does not satisfy the threshold, then a second prompt may be transmitted to a second model in a cloud computing environment, and second output may be received from the cloud computing environment and returned at step 210.

### EXAMPLES

Disclosed herein is an example two-stage cascading machine learning system comprising a pair of sequential models, a first model of the pair deferring to a second model of the pair if a confidence score (prediction, etc.) associated with an output associated with the first model fails to satisfy a threshold. Conventional practice dictates choosing thresholds using a receiver operating characteristic (ROC) curve at some desired risk-recall trade-off. However, this approach fails to properly control the risk in an opposing setting where the first model (first stage model, etc.) outperforms the second model (second stage model, etc.) on a subset of high-confidence queries. The systems and methods described herein fill this gap in the literature. The systems and methods described herein propose a novel, grounded method to pick thresholds having concentration bounds on an empirical risk of opposing cascading systems. Described herein are experiments on an automatic speech recognition system, showing that the approach described herein controls for marginal risk, whereas two conventional baselines do not.

### Illustrative Example

A two-pass keyword spotting system may comprise a lightweight, on-chip model (a first model) and a large, software-based neural network (a second model). To save power, the first model defers to the second model only if the first model produces output with a corresponding confidence score that fails to satisfy a threshold. The first model produces better output than the second model on a first subset of examples as confidence scores associated with output associated with the first subset of examples satisfies (rises above, etc.) the threshold. The first model produces worse output than the second model on a second subset of examples as confidence scores associated with output associated with the second subset of examples fails to satisfy (falls below, etc.) the threshold. Systems that comprise the first subset of examples and the second subset of examples may comprise a property called opposing cascading. The systems and methods described herein find a threshold to control a “marginal” risk such that the first model almost always falls back to the second model when the first model performs worse than the second model. To do this, standard practice suggests sweeping thresholds over a real interval to produce a receiver operating characteristic (ROC) curve, which may be used to pick a threshold closest to a desired risk.

The standard practice approach to choose a threshold has two shortcomings, however: first, it lacks concentration bounds on a probability of a risk surpassing a target risk, conditioned on a confidence passing the chosen threshold. Second, since ROC curves deal with average risk instead of marginal risk, the chosen threshold may incorrectly allow queries better handled by the second model to go to the first model.

To address these gaps in the prior art, the systems and methods herein propose a new framework for rigorously picking confidence thresholds in an opposing cascading setting, proving probabilistic theoretical bounds under general conditions. Experiments on a speech recognition system show that thresholds picked using the conventional ROC curve do not sufficiently control the marginal risk, consistently exceeding the target risk by double, whereas the systems and methods described herein do sufficiently control the marginal risk.

The systems and methods disclosed herein propose a novel method for picking a threshold that bounds a “marginal” risk of an opposing cascading system, based on a requirement that a first model be as accurate as a second model for all queries above the threshold (with high probability), not just on average. As an example, a threshold may be selected based on probability distribution that a first model be as accurate as a second model for all queries above the threshold.

The examples described herein bolster a validity of the systems and methods described herein, both theoretically and empirically, showing that the systems and methods described herein correctly control the risk of a cascading speech recognition system to a set error level, whereas conventional methods exceeded the error rate by an absolute 1-13%.

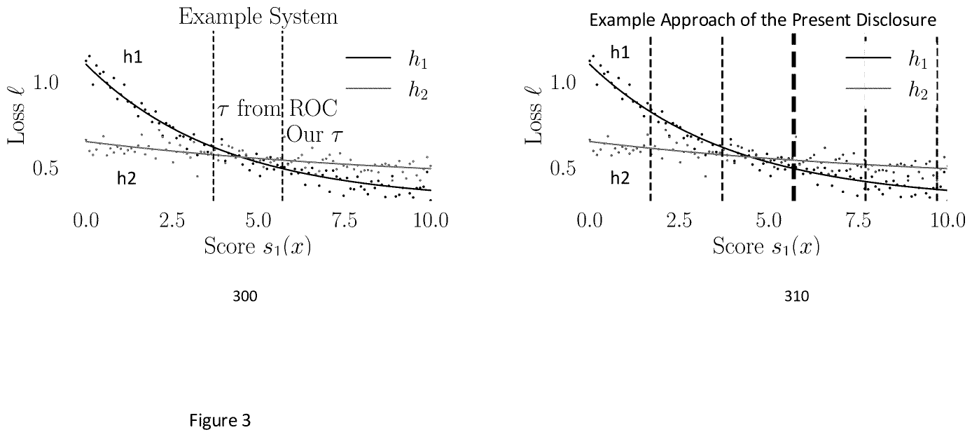

FIG. 3 shows example graphs 300, 310 comparing performance of conventional systems to the systems and methods described herein. Graph 300 shows example thresholds discovered by a conventional ROC (the leftmost substantially vertical line in 300) and the systems and methods described herein (the rightmost substantially vertical line in 300). The systems and methods described herein correctly control marginal risk. Each point in 300 represents an input example. Graph 310 shows a visualization of a partition-based algorithm of the systems and methods described herein. The two leftmost substantially vertical lines indicate thresholds violating the specified cutoff for the quality of the first system compared to the second (alpha) and the three rightmost substantially vertical lines indicate risk-controlling thresholds. The thick middle substantially vertical line being the lowest of the substantially vertical lines indicating risk-controlling thresholds and yielding the highest coverage of the three substantially vertical lines.

### Risk Control Approach for Opposing Cascading Models

### 2.1 General Framework

To formalize a mathematical framework described herein, a cascading system may be defined as a four-tuple (h₁, s₁, h₂, τ), where h₁, h₂:X→Y are the first- and second-stage models taking inputs in X and producing predictions in the Y output space, s₁:X→ [symbol] is a confidence score function for the first model, and τ is a real-valued threshold. Let the overall cascading system H:X→Y be

$$H ( x ) := \{ \begin{matrix}h 1 ( x ) if s 1 ( x ) \geq τ , \\ h 2 ( x ) otherwise\end{matrix} . \qquad ( 1 )$$

To measure the quality of h₁ and h₂, a nonnegative loss function [symbol] (y_{pred}) may be used, which is equal to zero if and only if the prediction y_{pred} is considered “ideal” with respect to the ground truth. Common examples of nonnegative loss functions may include measuring h₁ and h₂ for accuracy, negative log-likelihood, and perplexity. The confidence score has the property that an expected loss of h₁ decreases as the confidence score goes up, i.e., [symbol] [ [symbol] (h₁ (X₁))|s₁(X₁)≤s₁(X₂)]≥ [symbol] [ [symbol] (h₁(X₂))|s₁ (X₁)≤s₁ (X₂)] for X₁, X₂ drawn from [symbol] (X). In general, h₁ and h₂ need not be related. In reality, it has been shown that h₁ often increasingly outperforms h₂ as a prediction confidence score of h₁ by s₁ rises, even if the confidence score is not better on average. A simple scenario is if h₁ is a specialized model for a subset of a data distribution and h₂ is a more universal model. An example system may comprise a first-stage model covering a limited vocabulary with high accuracy and a second-stage fallback system for the whole vocabulary. If a cascading system has this property (a small, specialized model and a large general model), then the cascading system may be opposing:

Definition 1. A cascading system (h₁, s₁, h₂, ·) with loss [symbol] is said to be opposing if for all sequences X₁, . . . , Xₙ, each with sample space X and s₁(Xᵢ)≤s₁(Xⱼ) for all j≥i, the sequence of events

$${E}_{i} := ℓ ( {h}_{1} ( {X}_{i} ) ) \leq ℓ ( {h}_{2} ( {X}_{i} ) ) for 1 \leq i \leq n \qquad ( 2 )$$

$$satisfies ℙ ( {E}_{i + 1} ) \geq ℙ ( {E}_{i} ) .$$

### 2.2 Distribution-Free Marginal Risk Control

The marginal risk of a cascading system may be defined:

Definition 2. The marginal risk RM of the cascading system (h₁, s₁, h₂, τ) is

$${R}_{M} ( τ ) := sup \{ ℙ ( ℓ ( {h}_{1} ( X ) ) > ℓ ( {h}_{2} ( X ) ) ) : {s}_{1} ( X ) ∈ T , T ⊆ [ τ , ∞ ) \} . \qquad ( 3 )$$

Marginal risk may reflect a maximum conditional probability that the first model underperforms the second model, given that the confidence score is in a subset lower-bounded by τ. The systems and methods described herein pick, using a finite sample, a threshold that upper bounds the marginal risk of the system to α with probability 1−δ. The systems and methods described herein seek to estimate a threshold τ′ from empirical data such that

$$ℙ ( {R}_{M} ( {τ}^{′} ) \leq α ) \geq 1 - δ \qquad ( 4 )$$

for some provided 0≤δ≤1 and 0≤α≤1. A sample X₁, . . . , Xₙ may be provided and nothing about [symbol] (X) may be assumed, only that h₁ and h₂ are opposing. A simple idea is to partition X₁, . . . , Xₙ uniformly, by confidence score, bound the expected loss difference of each partition, then pick the τ′ that satisfies Eqn. (4) for each partition above τ′.

Proposition 1. Let X₁, . . . , Xₙ be an i.i.d. sample drawn from [symbol] (X), and suppose without loss of generality that s₁(Xᵢ)≤s₁(Xᵢ₊₁) for all 1≤i<n. Assume that n=km for positive integers k and m, and define k test statistics t₁, . . . , tₖ as

$${t}_{i} := sup \{ p : ℙ ( Binom ( m , p ) \leq {d}_{i} ) \geq δ \} , \qquad ( 5 )$$

where Binom (m, p) is the binomial distribution parameterized by m trials and p success probability, and dᵢ is the number of observed violations

$${d}_{i} := \# \{ j : ℓ ( {h}_{1} ( {X}_{k ( i - 1 ) + j} ) ) > ℓ ( {h}_{2} ( {X}_{k ( i - 1 ) + j} ) ) , 1 \leq j \leq m \} . \qquad ( 6 )$$

Then τ′:=s₁(X_{ki*) satisfies Eqn. (}4), where i*=argminᵢ{tᵢ:tᵢ≤α Λ∀j>i, tⱼ≤α}; τ′ controls the marginal risk of h1 to be below α with probability 1−δ. If the set is empty, then τ′ is undefined for the given parameters.

### Experiments

Experiments were used to empirically validate the systems and methods described herein. The experiments compare the systems and methods disclosed herein against two conventional baselines: first, a traditional ROC approach, where a threshold is chosen based on an average risk; second, a simpler variant of the systems and methods described herein without accounting for the 8 value, to demonstrate the utility of this step.

Experimental setup. 20,000 audio clips were collected from in-production voice query traffic. The audio clips were sent to a first-stage automatic speech recognition (ASR) system, (h₁) and the second-stage ASR system (h₂) for comparison. h₁ ran on a single Nvidia Telsa V100 GPU with 16 GB of VRAM, while h₂ on a cloud-based service. The results were sorted by confidence score s₁. 100 down-sampled datasets were created by randomly drawing 10% of the audio clips without replacement 100 times. In each dataset, 10-fold cross validation was applied as a train-test task with a bucket size of 100. If a threshold that satisfied α with level δ could not be computed, the threshold was set to a lowest confidence score of the training set. For each thresholding method, the threshold was calculated for 30 evenly spaced a values from [0.2, 0.7]. The experiments set δ=0.9.

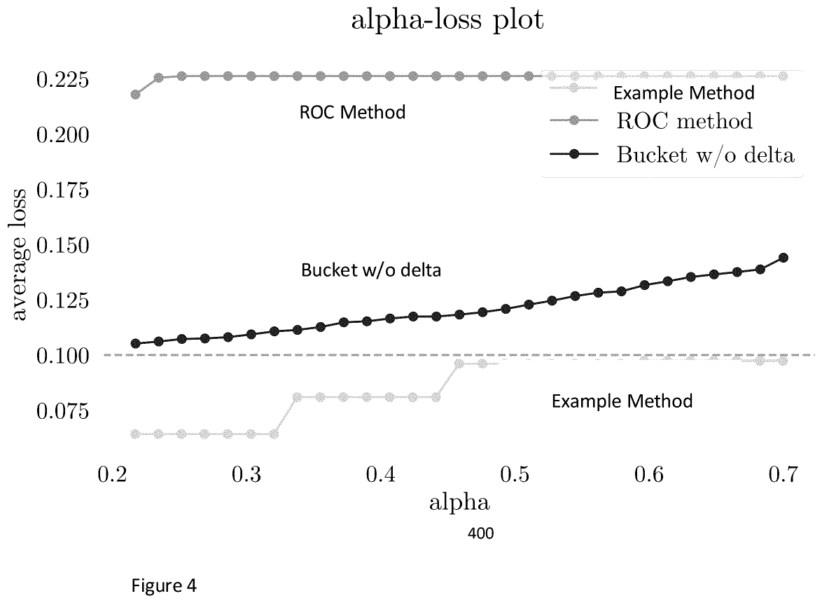

Results. Across 100 test sets, τ(α) was used to calculate the thresholds for each of the three methods. For each τ(α), the average loss was computed across all the test sets. The relationship between average loss and α was compared across three methods in the chart 400 in FIG. 4. FIG. 4 shows an example graph 400 comparing average loss of various methods, including the systems and methods described herein. The graph 400 shows an average loss of first-stage system for thresholds computed by various methods as a function of alpha. A dashed line running substantially horizontal at about 0.1 average loss in graph 400 denotes a desired probability of exceeding the set α (i.e., 1−δ). The ROC method presents the poorest control over average loss (see the topmost series of dots connected by lines in 400), consistently surpassing the desired risk by more than double. The bucket method (see the middle series of dots connected by lines in 400) without delta outperforms the ROC method but still does not fall below 0.1 in risk, since the ROC method likewise does not provide a control mechanism. Finally, systems and methods described herein (see the bottom series of dots connected by lines in 400), which precisely control for the risk using a δ=0.9, maintain the average loss rigorously below 0.1 for all a values.

The systems and methods described herein find applicability in ASR scenarios, such as a voice controlled remote control. For example, a keyword spotting system may use a first-stage on-device model and a second-stage cloud solution. The systems and methods described herein could enable precise risk control within ASR systems.

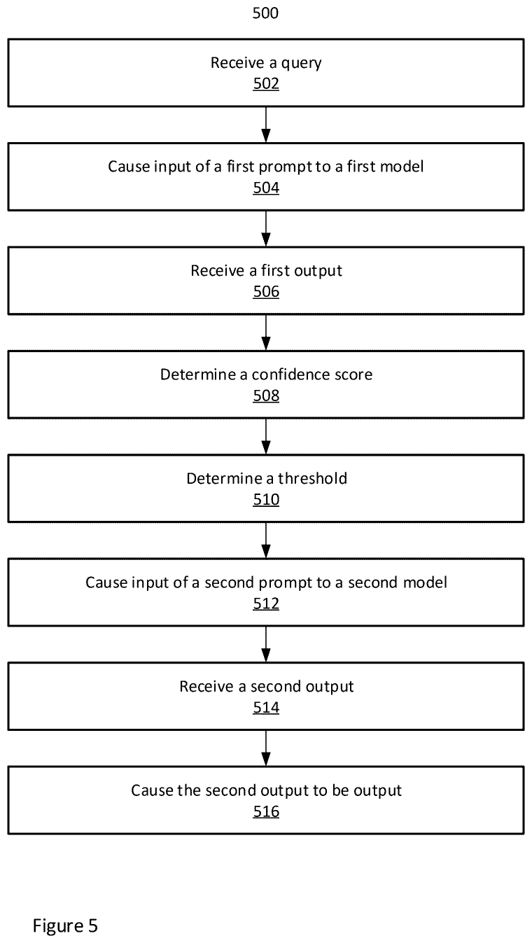

FIG. 5 is a flowchart of an example process 500. In some implementations, one or more process blocks of FIG. 5 may be performed by the local computing device 110 in FIG. 1 and/or the remote computing device 120 in FIG. 1.

As shown in FIG. 5, process 500 may include receiving a query (block 502). The query may be received via a computing device. For example, the local computing device 110 may receive a query. As another example, the remote computing device 120 may receive a query. The query may comprise an indication of a voice command.

As also shown in FIG. 5, process 500 may include causing input of a first prompt to a first model (block 504). For example, the local computing device 110 may cause input of a first prompt to a first model. As another example, the remote computing device 120 may cause input of a first prompt to a first model. The first prompt may be based on the query. The first model may include a first large language model (LLM). The computing device may comprise the first model. The computing device may be in communication with a local computing device. The local computing device may comprise the first model.

As further shown in FIG. 5, process 500 may include receiving a first output (block 506). For example, the local computing device 110 may receive a first output. As another example, the remote computing device 120 may receive a first output. The first output may be received via the first model.

As also shown in FIG. 5, process 500 may include determining a confidence score (block 508). For example, the local computing device 110 may determine a confidence score. As another example, the remote computing device 120 may determine a confidence score. The confidence score may be determined based on the first output. The confidence score may be based, at least in part, on a number of times a previous query has been the same as the query. The confidence score may be based, at least in part, on feedback received the number of times the previous query has been the same as the query. The determining a confidence score may comprise receiving the confidence score from the first model.

The query may comprise an indication of a voice command. The confidence score may be based, at least in part, on an interpretation of the voice command. The confidence score may be based, at least in part, on a frequency of the interpretation of the voice command being the same as or similar to previous interpretations of voice commands. The confidence score may be based, at least in part, on a frequency of the interpretation of the voice command being the same as or similar to previous interpretations of voice commands within a time period.

As further shown in FIG. 5, process 500 may include determining a threshold (block 510). For example, the local computing device 110 may determine a threshold. As another example, the remote computing device 120 may determine a threshold. The threshold may be determined based on a comparison of a first performance of the first model and a second performance of a second model. The second model may include a second LLM. The comparison of the first performance and the second performance may include a comparison of at least one of accuracy, negative log-likelihood, or perplexity. The computing device may be in communication with a remote computing device via a network. The remote computing device may comprise the second model.

The first performance of the first model may be based on a nonnegative loss function. The second performance of the second model may be based on the nonnegative loss function. The comparison of the first performance of the first model and the second performance of the second model may comprise comparing a first result of a first prediction from the first model applied to the nonnegative loss function with a second result of a second prediction from the second model applied to the nonnegative loss function.

The first model may be smaller (e.g., based on number of parameters or other common metric) than the second model. The first model may produce output quicker than the second model based on the same input. A first computing device may comprise the first model. A second computing device may comprise the second model. The first computing device may comprise less computing power than the second computing device. The first model may reside in one of a gateway, a cable modem, or a set-top box. The second model may reside in one of a server or a cloud computing environment.

As also shown in FIG. 5, process 500 may include causing input of a second prompt to the second model (block 512). For example, the local computing device 110 may cause input of a second prompt to the second model. As another example, the remote computing device 120 may cause input of a second prompt to the second model. The input of the second prompt to the second model may be caused based on the confidence score not satisfying the threshold. The second prompt may be based at least on the query.

As further shown in FIG. 5, process 500 may include receiving a second output (block 514). For example, the local computing device 110 may receive a second output. As another example, the remote computing device 120 may receive a second output. The second output may be received via the second model.

As also shown in FIG. 5, process 500 may include causing the second output to be output (block 516). For example, the local computing device 110 may cause the second output to be output. As another example, the remote computing device 120 may cause the second output to be output. The second output may be output based on the query. The second output may be output via the computing device.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

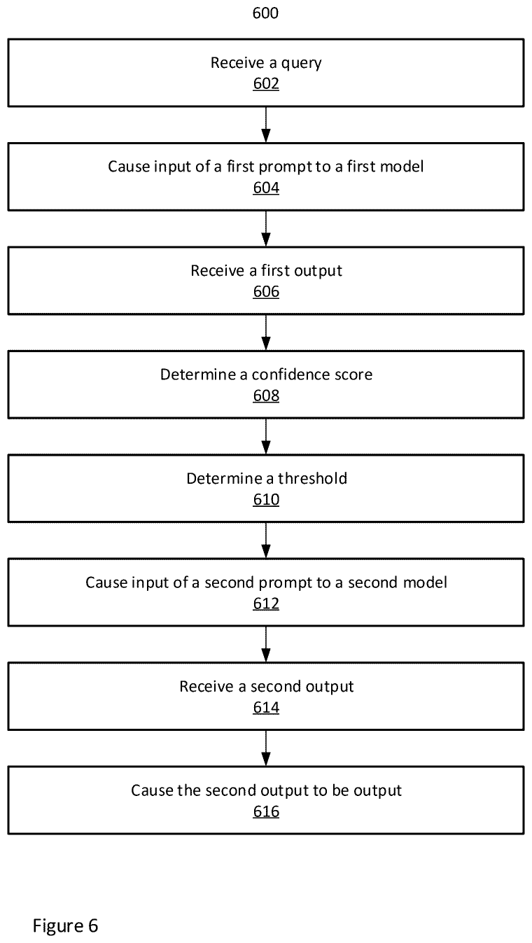

FIG. 6 is a flowchart of an example process 600. In some implementations, one or more process blocks of FIG. 6 may be performed by the local computing device 110 in FIG. 1 and/or the remote computing device 120 in FIG. 1.

As shown in FIG. 6, process 600 may include receiving a query (block 602). The query may be received via a computing device. For example, the local computing device 110 may receive a query. As another example, the remote computing device 120 may receive a query. The query may comprise an indication of a voice command.

As also shown in FIG. 6, process 600 may include causing input of a first prompt to a first model (block 604). For example, the local computing device 110 may cause input of a first prompt to a first model. As another example, the remote computing device 120 may cause input of a first prompt to a first model. The first prompt may be based on the query. The first model may include a first large language model (LLM). The computing device may comprise the first model. The computing device may be in communication with a local computing device. The local computing device may comprise the first model.

As further shown in FIG. 6, process 600 may include receiving a first output (block 606). For example, the local computing device 110 may receive a first output. As another example, the remote computing device 120 may receive a first output. The first output may be received via the first model.

As also shown in FIG. 6, process 600 may include determining a confidence score (block 608). For example, the local computing device 110 may determine a confidence score. As another example, the remote computing device 120 may determine a confidence score. The confidence score may be determined based on the first output. The determining a confidence score may comprise receiving the confidence score from the first model.

The query may comprise an indication of a voice command. The confidence score may be based, at least in part, on an interpretation of the voice command. The confidence score may be based, at least in part, on a frequency of the interpretation of the voice command being the same as or similar to previous interpretations of voice commands. The confidence score may be based, at least in part, on a frequency of the interpretation of the voice command being the same as or similar to previous interpretations of voice commands within a time period.

As further shown in FIG. 6, process 600 may include determining a threshold (block 610). For example, the local computing device 110 may determine a threshold. As another example, the remote computing device 120 may determine a threshold. The threshold may be determined based on a comparison of a first performance of the first model and a second performance of a second model. The second model may include a second LLM. The computing device may be in communication with a remote computing device via a network. The remote computing device may comprise the second model.

The first performance of the first model may be based on a nonnegative loss function. The second performance of the second model may be based on the nonnegative loss function. The comparison of the first performance of the first model and the second performance of the second model may comprise comparing a first result of a first prediction from the first model applied to the nonnegative loss function with a second result of a second prediction from the second model applied to the nonnegative loss function.

The first model may be smaller (e.g., based on number of parameters or other common metric) than the second model. The first model may produce output quicker than the second model based on the same input. A first computing device may comprise the first model. A second computing device may comprise the second model. The first computing device may comprise less computing power than the second computing device. The first model may reside in one of a gateway, a cable modem, or a set-top box. The second model may reside in one of a server or a cloud computing environment.

As also shown in FIG. 6, process 600 may include causing input of a second prompt to the second model (block 612). For example, the local computing device 110 may cause input of a second prompt to the second model. As another example, the remote computing device 120 may cause input of a second prompt to the second model. The input of the second prompt to the second model may be caused based on the confidence score not satisfying the threshold. The second prompt may be based at least on the query.

As further shown in FIG. 6, process 600 may include receiving a second output (block 614). For example, the local computing device 110 may receive a second output. As another example, the remote computing device 120 may receive a second output. The second output may be received via the second model.

As also shown in FIG. 6, process 600 may include causing the second output to be output (block 616). For example, the local computing device 110 may cause the second output to be output. As another example, the remote computing device 120 may cause the second output to be output. The second output may be output based on the query. The second output may be output via the computing device.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

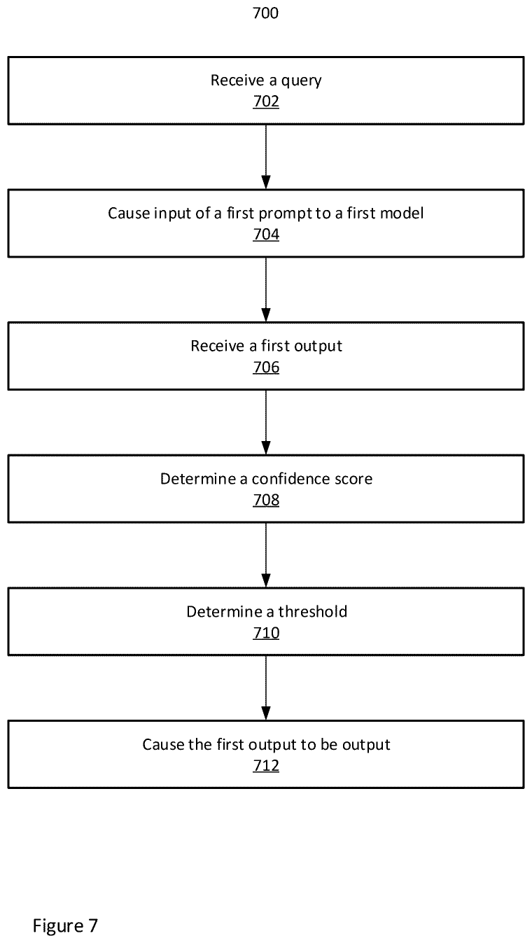

FIG. 7 is a flowchart of an example process 700. In some implementations, one or more process blocks of FIG. 7 may be performed by the local computing device 110 in FIG. 1 and/or the remote computing device 120 in FIG. 1.

As shown in FIG. 7, process 600 may include receiving a query (block 702). The query may be received via a computing device. For example, the local computing device 110 may receive a query. As another example, the remote computing device 120 may receive a query. The query may comprise an indication of a voice command.

As also shown in FIG. 7, process 700 may include causing input of a first prompt to a first model (block 704). For example, the local computing device 110 may cause input of a first prompt to a first model. As another example, the remote computing device 120 may cause input of a first prompt to a first model. The first prompt may be based on the query. The first model may include a first large language model (LLM). The computing device may comprise the first model. The computing device may be in communication with a local computing device. The local computing device may comprise the first model.

As further shown in FIG. 7, process 700 may include receiving a first output (block 706). For example, the local computing device 110 may receive a first output. As another example, the remote computing device 120 may receive a first output. The first output may be received via the first model.

As also shown in FIG. 7, process 700 may include determining a confidence score (block 708). For example, the local computing device 110 may determine a confidence score. As another example, the remote computing device 120 may determine a confidence score. The confidence score may be determined based on the first output. The determining a confidence score may comprise receiving the confidence score from the first model.

The query may comprise an indication of a voice command. The confidence score may be based, at least in part, on an interpretation of the voice command. The confidence score may be based, at least in part, on a frequency of the interpretation of the voice command being the same as or similar to previous interpretations of voice commands. The confidence score may be based, at least in part, on a frequency of the interpretation of the voice command being the same as or similar to previous interpretations of voice commands within a time period.

As further shown in FIG. 7, process 700 may include determining a threshold (block 710). For example, the local computing device 110 may determine a threshold. As another example, the remote computing device 120 may determine a threshold. The threshold may be determined based on a comparison of a first performance of the first model and a second performance of a second model. The second model may include a second LLM. The computing device may be in communication with a remote computing device via a network. The remote computing device may comprise the second model.

The first performance of the first model may be based on a nonnegative loss function. The second performance of the second model may be based on the nonnegative loss function. The comparison of the first performance of the first model and the second performance of the second model may comprise comparing a first result of a first prediction from the first model applied to the nonnegative loss function with a second result of a second prediction from the second model applied to the nonnegative loss function.

The first model may be smaller (e.g., based on number of parameters or other common metric) than the second model. The first model may produce output quicker than the second model based on the same input. A first computing device may comprise the first model. A second computing device may comprise the second model. The first computing device may comprise less computing power than the second computing device. The first model may reside in one of a gateway, a cable modem, or a set-top box. The second model may reside in one of a server or a cloud computing environment.

As also shown in FIG. 7, process 700 may include causing the first output to be output (block 712). For example, the local computing device 110 may cause the first output to be output. As another example, the remote computing device 120 may cause the first output to be output. The first output may be output based on the confidence score satisfying the threshold. The first output may be output via the computing device.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

Example Clause 1: A method may include: receiving, via a computing device, a query; causing, based on the query, input of a first prompt to a first model, where the first model may include a first large language model (LLM); receiving, via the first model, a first output; determining, based on the first output, a confidence score, where the confidence score is based, at least in part, on a number of times a previous query has been the same as the query, and where the confidence score is based, at least in part, on feedback received the number of times the previous query has been the same as the query; determining, based on a comparison of a first performance of the first model and a second performance of a second model, a threshold, where the second model may include a second LLM, and where the comparison of the first performance and the second performance may include a comparison of at least one of accuracy, negative log-likelihood, or perplexity; causing, based on the confidence score not satisfying the threshold, input of a second prompt to the second model, where the second prompt is based at least on the query; receiving, via the second model, a second output; and causing, based on the query, the second output to be output via the computing device.

Example Clause 2: The method of Example Clause 1, where the computing device may include the first model.

Example Clause 3: The method of Example Clause 1 or Example Clause 2, where the computing device is in communication with a local computing device, and where the local computing device may include the first model.

Example Clause 4: The method of any one of Example Clauses 1-3, where the computing device is in communication with a remote computing device via a network, and where the remote computing device may include the second model.

Example Clause 5: The method of any one of Example Clauses 1-4, where the query may include an indication of a voice command.

Example Clause 6: The method of any one of Example Clauses 1-5, where the determining a confidence score may include receiving the confidence score from the first model.

Example Clause 7: The method of any one of Example Clauses 1-6, where the first performance of the first model is based on a nonnegative loss function.

Example Clause 8: The method of any one of Example Clauses 1-7, where the second performance of the second model is based on the nonnegative loss function.

Example Clause 9: The method of any one of Example Clauses 1-8, where the comparison of the first performance of the first model and the second performance of the second model may include comparing a first result of a first prediction from the first model applied to the nonnegative loss function with a second result of a second prediction from the second model applied to the nonnegative loss function.

Example Clause 10: The method of any one of Example Clauses 1-9, where the first model is smaller than the second model.

Example Clause 11: The method of any one of Example Clauses 1-10, where the first model produces output quicker than the second model.

Example Clause 12: The method of any one of Example Clauses 1-11, where a first computing device may include the first model, where a second computing device may include the second model, and where the first computing device may include less computing power than the second computing device.

Example Clause 13: The method of any one of Example Clauses 1-12, where the first model resides in one of a gateway, a cable modem, or a set-top box, and where the second model resides in one of a server or a cloud computing environment.

Example Clause 14: The method of any one of Example Clauses 1-13, where the query may include an indication of a voice command and where the confidence score is based, at least in part, on an interpretation of the voice command.

Example Clause 15: The method of any one of Example Clauses 1-14, where the confidence score is based, at least in part, on a frequency of the interpretation of the voice command being the same as or similar to previous interpretations of voice commands.

Example Clause 16: The method of any one of Example Clauses 1-15, where the confidence score is based, at least in part, on a frequency of the interpretation of the voice command being the same as or similar to previous interpretations of voice commands within a time period.

Example Clause 17: A method may include: receiving, via a computing device, a query; causing, based on the query, input of a first prompt to a first model; receiving, via the first model, a first output; determining, based on the first output, a confidence score; determining, based on a comparison of a first performance of the first model and a second performance of a second model, a threshold; causing, based on the confidence score not satisfying the threshold, input of a second prompt to the second model, where the second prompt is based at least on the query; receiving, via the second model, a second output; and causing, based on the query, the second output to be output via the computing device.

Example Clause 18: The method of Example Clause 17, where the computing device may include the first model.

Example Clause 19: The method of Example Clause 17 or Example Clause 18, where the computing device is in communication with a local computing device, and where the local computing device may include the first model.

Example Clause 20: The method of any one of Example Clauses 17-19, where the computing device is in communication with a remote computing device via a network, and where the remote computing device may include the second model.

Example Clause 21: The method of any one of Example Clauses 17-20, where the query may include an indication of a voice command.

Example Clause 22: The method of any one of Example Clauses 17-21, where the determining a confidence score may include receiving the confidence score from the first model.

Example Clause 23: The method of any one of Example Clauses 17-22, where the first performance of the first model is based on a nonnegative loss function.

Example Clause 24: The method of any one of Example Clauses 17-23, where the second performance of the second model is based on the nonnegative loss function.

Example Clause 25: The method of any one of Example Clauses 17-24, where the comparison of the first performance of the first model and the second performance of the second model may include comparing a first result of a first prediction from the first model applied to the nonnegative loss function with a second result of a second prediction from the second model applied to the nonnegative loss function.

Example Clause 26: The method of any one of Example Clauses 17-25, where the first model is smaller than the second model.

Example Clause 27: The method of any one of Example Clauses 17-26, where the first model produces output quicker than the second model.

Example Clause 28: The method of any one of Example Clauses 17-27, where a first computing device may include the first model, where a second computing device may include the second model, and where the first computing device may include less computing power than the second computing device.

Example Clause 29: The method of any one of Example Clauses 17-28, where the first model resides in one of a gateway, a cable modem, or a set-top box, and where the second model resides in one of a server or a cloud computing environment.

Example Clause 30: The method of any one of Example Clauses 17-29, where the query may include an indication of a voice command and where the confidence score is based, at least in part, on an interpretation of the voice command.

Example Clause 31: The method of any one of Example Clauses 17-30, where the confidence score is based, at least in part, on a frequency of the interpretation of the voice command being the same as or similar to previous interpretations of voice commands.

Example Clause 32: The method of any one of Example Clauses 17-31, where the confidence score is based, at least in part, on a frequency of the interpretation of the voice command being the same as or similar to previous interpretations of voice commands within a time period.

Example Clause 33: A method may include: receiving, via a computing device, a query; causing, based on the query, input of a first prompt to a first model; receiving, via the first model, a first output; determining, based on the first output, a confidence score; determining, based on a comparison of a first performance of the first model and a second performance of a second model, a threshold; and causing, based on the confidence score satisfying the threshold, the first output to be output via the computing device.

Example Clause 34: The method of Example Clause 33, where the computing device may include the first model.

Example Clause 35: The method of Example Clause 33 or Example Clause 34, where the computing device is in communication with a local computing device, and where the local computing device may include the first model.

Example Clause 36: The method of any one of Example Clauses 33-35, where the computing device is in communication with a remote computing device via a network, and where the remote computing device may include the second model.

Example Clause 37: The method of any one of Example Clauses 33-36, where the query may include an indication of a voice command.

Example Clause 38: The method of any one of Example Clauses 33-37, where the determining a confidence score may include receiving the confidence score from the first model.

Example Clause 39: The method of any one of Example Clauses 33-38, where the first performance of the first model is based on a nonnegative loss function.

Example Clause 40: The method of any one of Example Clauses 33-39, where the second performance of the second model is based on the nonnegative loss function.

Example Clause 41: The method of any one of Example Clauses 33-40, where the comparison of the first performance of the first model and the second performance of the second model may include comparing a first result of a first prediction from the first model applied to the nonnegative loss function with a second result of a second prediction from the second model applied to the nonnegative loss function.

Example Clause 42: The method of any one of Example Clauses 33-41, where the first model is smaller than the second model.

Example Clause 43: The method of any one of Example Clauses 33-42, where the first model produces output quicker than the second model.

Example Clause 44: The method of any one of Example Clauses 33-43, where a first computing device may include the first model, where a second computing device may include the second model, and where the first computing device may include less computing power than the second computing device.

Example Clause 45: The method of any one of Example Clauses 33-44, where the first model resides in one of a gateway, a cable modem, or a set-top box, and where the second model resides in one of a server or a cloud computing environment.

Example Clause 46: The method of any one of Example Clauses 33-45, where the query may include an indication of a voice command and where the confidence score is based, at least in part, on an interpretation of the voice command.

Example Clause 47: The method of any one of Example Clauses 33-46, where the confidence score is based, at least in part, on a frequency of the interpretation of the voice command being the same as or similar to previous interpretations of voice commands.

Example Clause 48: The method of any one of Example Clauses 33-47, where the confidence score is based, at least in part, on a frequency of the interpretation of the voice command being the same as or similar to previous interpretations of voice commands within a time period.

Example Clause 49: A system may include: one or more processors configured to: receive, via a computing device, a query; cause, based on the query, input of a first prompt to a first model, where the first model may include a first large language model (LLM); receive, via the first model, a first output; determine, based on the first output, a confidence score, where the confidence score is based, at least in part, on a number of times a previous query has been the same as the query, and where the confidence score is based, at least in part, on feedback received the number of times the previous query has been the same as the query; determine, based on a comparison of a first performance of the first model and a second performance of a second model, a threshold, where the second model may include a second LLM, and where the comparison of the first performance and the second performance may include a comparison of at least one of accuracy, negative log-likelihood, or perplexity; cause, based on the confidence score not satisfying the threshold, input of a second prompt to the second model, where the second prompt is based at least on the query; receive, via the second model, a second output; and cause, based on the query, the second output to be output via the computing device.

Example Clause 50: The system of Example Clause 49, where the computing device may include the first model.

Example Clause 51: The system of Example Clause 49 or Example Clause 50, where the computing device is in communication with a local computing device, and where the local computing device may include the first model.

Example Clause 52: The system of any one of Example Clauses 49-51, where the computing device is in communication with a remote computing device via a network, and where the remote computing device may include the second model.

Example Clause 53: The system of any one of Example Clauses 49-52, where the query may include an indication of a voice command.

Example Clause 54: The system of any one of Example Clauses 49-53, where the determining a confidence score may include receiving the confidence score from the first model.

Example Clause 55: The system of any one of Example Clauses 49-54, where the first performance of the first model is based on a nonnegative loss function.

Example Clause 56: The system of any one of Example Clauses 49-55, where the second performance of the second model is based on the nonnegative loss function.

Example Clause 57: The system of any one of Example Clauses 49-56, where the comparison of the first performance of the first model and the second performance of the second model may include comparing a first result of a first prediction from the first model applied to the nonnegative loss function with a second result of a second prediction from the second model applied to the nonnegative loss function.

Example Clause 58: The system of any one of Example Clauses 49-57, where the first model is smaller than the second model.

Example Clause 59: The system of any one of Example Clauses 49-58, where the first model produces output quicker than the second model.

Example Clause 60: The system of any one of Example Clauses 49-59, where a first computing device may include the first model, where a second computing device may include the second model, and where the first computing device may include less computing power than the second computing device.

Example Clause 61: The system of any one of Example Clauses 49-60, where the first model resides in one of a gateway, a cable modem, or a set-top box, and where the second model resides in one of a server or a cloud computing environment.

Example Clause 62: The system of any one of Example Clauses 49-61, where the query may include an indication of a voice command and where the confidence score is based, at least in part, on an interpretation of the voice command.

Example Clause 63: The system of any one of Example Clauses 49-62, where the confidence score is based, at least in part, on a frequency of the interpretation of the voice command being the same as or similar to previous interpretations of voice commands.

Example Clause 64: The system of any one of Example Clauses 49-63, where the confidence score is based, at least in part, on a frequency of the interpretation of the voice command being the same as or similar to previous interpretations of voice commands within a time period.

Example Clause 65: A system may include: one or more processors configured to: receive, via a computing device, a query; cause, based on the query, input of a first prompt to a first model; receive, via the first model, a first output; determine, based on the first output, a confidence score; determine, based on a comparison of a first performance of the first model and a second performance of a second model, a threshold; cause, based on the confidence score not satisfying the threshold, input of a second prompt to the second model, where the second prompt is based at least on the query; receive, via the second model, a second output; and cause, based on the query, the second output to be output via the computing device.

Example Clause 66: The system of Example Clause 65, where the computing device may include the first model.

Example Clause 67: The system of Example Clause 65 or Example Clause 66, where the computing device is in communication with a local computing device, and where the local computing device may include the first model.

Example Clause 68: The system of any one of Example Clauses 65-67, where the computing device is in communication with a remote computing device via a network, and where the remote computing device may include the second model.

Example Clause 69: The system of any one of Example Clauses 65-68, where the query may include an indication of a voice command.

Example Clause 70: The system of any one of Example Clauses 65-69, where the determining a confidence score may include receiving the confidence score from the first model.

Example Clause 71: The system of any one of Example Clauses 65-70, where the first performance of the first model is based on a nonnegative loss function.

Example Clause 72: The system of any one of Example Clauses 65-71, where the second performance of the second model is based on the nonnegative loss function.

Example Clause 73: The system of any one of Example Clauses 65-72, where the comparison of the first performance of the first model and the second performance of the second model may include comparing a first result of a first prediction from the first model applied to the nonnegative loss function with a second result of a second prediction from the second model applied to the nonnegative loss function.

Example Clause 74: The system of any one of Example Clauses 65-73, where the first model is smaller than the second model.

Example Clause 75: The system of any one of Example Clauses 65-74, where the first model produces output quicker than the second model.

Example Clause 76: The system of any one of Example Clauses 65-75, where a first computing device may include the first model, where a second computing device may include the second model, and where the first computing device may include less computing power than the second computing device.

Example Clause 77: The system of any one of Example Clauses 65-76, where the first model resides in one of a gateway, a cable modem, or a set-top box, and where the second model resides in one of a server or a cloud computing environment.

Example Clause 78: The system of any one of Example Clauses 65-77, where the query may include an indication of a voice command and where the confidence score is based, at least in part, on an interpretation of the voice command.

Example Clause 79: The system of any one of Example Clauses 65-78, where the confidence score is based, at least in part, on a frequency of the interpretation of the voice command being the same as or similar to previous interpretations of voice commands.

Example Clause 80: The system of any one of Example Clauses 65-79, where the confidence score is based, at least in part, on a frequency of the interpretation of the voice command being the same as or similar to previous interpretations of voice commands within a time period.

Example Clause 81: A system may include: one or more processors configured to: receive, via a computing device, a query; cause, based on the query, input of a first prompt to a first model; receive, via the first model, a first output; determine, based on the first output, a confidence score; determine, based on a comparison of a first performance of the first model and a second performance of a second model, a threshold; and cause, based on the confidence score satisfying the threshold, the first output to be output via the computing device.

Example Clause 82: The system of Example Clause 81, where the computing device may include the first model.

Example Clause 83: The system of Example Clause 81 or Example Clause 82, where the computing device is in communication with a local computing device, and where the local computing device may include the first model.

Example Clause 84: The system of any one of Example Clauses 81-83, where the computing device is in communication with a remote computing device via a network, and where the remote computing device may include the second model.

Example Clause 85: The system of any one of Example Clauses 81-84, where the query may include an indication of a voice command.

Example Clause 86: The system of any one of Example Clauses 81-85, where the determining a confidence score may include receiving the confidence score from the first model.

Example Clause 87: The system of any one of Example Clauses 81-86, where the first performance of the first model is based on a nonnegative loss function.

Example Clause 88: The system of any one of Example Clauses 81-87, where the second performance of the second model is based on the nonnegative loss function.

Example Clause 89: The system of any one of Example Clauses 81-88, where the comparison of the first performance of the first model and the second performance of the second model may include comparing a first result of a first prediction from the first model applied to the nonnegative loss function with a second result of a second prediction from the second model applied to the nonnegative loss function.

Example Clause 90: The system of any one of Example Clauses 81-89, where the first model is smaller than the second model.

Example Clause 91: The system of any one of Example Clauses 81-90, where the first model produces output quicker than the second model.

Example Clause 92: The system of any one of Example Clauses 81-91, where a first computing device may include the first model, where a second computing device may include the second model, and where the first computing device may include less computing power than the second computing device.

Example Clause 93: The system of any one of Example Clauses 81-92, where the first model resides in one of a gateway, a cable modem, or a set-top box, and where the second model resides in one of a server or a cloud computing environment.

Example Clause 94: The system of any one of Example Clauses 81-93, where the query may include an indication of a voice command and where the confidence score is based, at least in part, on an interpretation of the voice command.

Example Clause 95: The system of any one of Example Clauses 81-94, where the confidence score is based, at least in part, on a frequency of the interpretation of the voice command being the same as or similar to previous interpretations of voice commands.

Example Clause 96: The system of any one of Example Clauses 81-95, where the confidence score is based, at least in part, on a frequency of the interpretation of the voice command being the same as or similar to previous interpretations of voice commands within a time period.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving, via a computing device, a query;
causing, based on the query, input of a first prompt to a first model, wherein the first model comprises a first large language model (LLM);
receiving, via the first model, a first output;
determining, based on the first output, a confidence score, wherein the confidence score is based, at least in part, on a number of times a previous query has been the same as the query, and wherein the confidence score is based, at least in part, on feedback received the number of times the previous query has been the same as the query;
determining, based on a comparison of a first performance of the first model and a second performance of a second model, a threshold, wherein the second model comprises a second LLM, and wherein the comparison of the first performance and the second performance comprises a comparison of at least one of accuracy, negative log-likelihood, or perplexity;
causing, based on the confidence score not satisfying the threshold, input of a second prompt to the second model, wherein the second prompt is based at least on the query;
receiving, via the second model, a second output; and
causing, based on the query, the second output to be output via the computing device.

2. The method of claim 1, wherein the determining a confidence score comprises receiving the confidence score from the first model.

3. The method of claim 1, wherein the first performance of the first model is based on a nonnegative loss function.

4. The method of claim 3, wherein the second performance of the second model is based on the nonnegative loss function.

5. The method of claim 4, wherein the comparison of the first performance of the first model and the second performance of the second model comprises comparing a first result of a first prediction from the first model applied to the nonnegative loss function with a second result of a second prediction from the second model applied to the nonnegative loss function.

6. The method of claim 1, wherein the first model produces output quicker than the second model based on the same input.

7. The method of claim 1, wherein a first computing device comprises the first model, wherein a second computing device comprises the second model, and wherein the first computing device comprises less computing power than the second computing device.

8. The method of claim 1, wherein the first model resides in one of a gateway, a cable modem, or a set-top box, and wherein the second model resides in one of a server or a cloud computing environment.

9. The method of claim 1, wherein the query comprises an indication of a voice command and wherein the confidence score is based, at least in part, on an interpretation of the voice command.

10. The method of claim 9, wherein the confidence score is based, at least in part, on a frequency of the interpretation of the voice command being the same as or similar to previous interpretations of voice commands.

11. The method of claim 10, wherein the confidence score is based, at least in part, on a frequency of the interpretation of the voice command being the same as or similar to previous interpretations of voice commands within a time period.

12. A method comprising:
receiving, via a computing device, a query;
causing, based on the query, input of a first prompt to a first model;
receiving, via the first model, a first output;
determining, based on the first output, a confidence score;
determining, based on a comparison of a first performance of the first model and a second performance of a second model, a threshold;
causing, based on the confidence score not satisfying the threshold, input of a second prompt to the second model, wherein the second prompt is based at least on the query;
receiving, via the second model, a second output; and
causing, based on the query, the second output to be output via the computing device.

13. The method of claim 12, wherein the determining a confidence score comprises receiving the confidence score from the first model.

14. The method of claim 12, wherein the first performance of the first model is based on a nonnegative loss function.

15. The method of claim 14, wherein the second performance of the second model is based on the nonnegative loss function.

16. The method of claim 15, wherein the comparison of the first performance of the first model and the second performance of the second model comprises comparing a first result of a first prediction from the first model applied to the nonnegative loss function with a second result of a second prediction from the second model applied to the nonnegative loss function.

17. The method of claim 12, wherein the first model produces output quicker than the second model based on the same input.

18. The method of claim 12, wherein a first computing device comprises the first model, wherein a second computing device comprises the second model, and wherein the first computing device comprises less computing power than the second computing device.

19. The method of claim 12, wherein the first model resides in one of a gateway, a cable modem, or a set-top box, and wherein the second model resides in one of a server or a cloud computing environment.

20. The method of claim 12, wherein the query comprises an indication of a voice command and wherein the confidence score is based, at least in part, on an interpretation of the voice command.

21. The method of claim 20, wherein the confidence score is based, at least in part, on a frequency of the interpretation of the voice command being the same as or similar to previous interpretations of voice commands.

22. The method of claim 20, wherein the confidence score is based, at least in part, on a frequency of the interpretation of the voice command being the same as or similar to previous interpretations of voice commands within a time period.

23. A method comprising:
receiving, via a computing device, a query;
causing, based on the query, input of a first prompt to a first model;
receiving, via the first model, a first output;
determining, based on the first output, a confidence score;
determining, based on a comparison of a first performance of the first model and a second performance of a second model, a threshold; and
causing, based on the confidence score satisfying the threshold, the first output to be output via the computing device.

24. The method of claim 23, wherein the determining a confidence score comprises receiving the confidence score from the first model.

25. The method of claim 23, wherein the first performance of the first model is based on a nonnegative loss function.

26. The method of claim 23, wherein the second performance of the second model is based on a nonnegative loss function.

27. The method of claim 23, wherein the comparison of the first performance of the first model and the second performance of the second model comprises comparing a first result of a first prediction from the first model applied to a nonnegative loss function with a second result of a second prediction from the second model applied to the nonnegative loss function.

28. The method of claim 23, wherein the first model produces output quicker than the second model based on the same input.

29. The method of claim 23, wherein a first computing device comprises the first model, wherein a second computing device comprises the second model, and wherein the first computing device comprises less computing power than the second computing device.
